(19) United States
(12) Patent Application Publication
(10) Pub. No.: US 2017/0340980 A1
(43) Pub. Date: Nov. 30, 2017

(54) Imagination Blocks

(71) Applicant: Chris M. Marcil, Warren, MA (US)

(72) Inventor: Chris M. Marcil, Warren, MA (US)

(21) Appl. No.: 15/680,215

(22) Filed: Aug. 18, 2017

Related U.S. Application Data
(63) Continuation-in-part of application No. 15/047,315, filed on Feb. 18, 2016.

(51) Int. Cl. A63H 33/04; A63H 33/26; A63H 33/40; B43L 1/00

(52) U.S. Cl. CPC A63H 33/046; B43L 1/004; A63H 33/042; A63H 33/26; A63H 33/40

(57) ABSTRACT

Building blocks for making structures comprising a number of translucent inflatable blocks, wherein each translucent inflatable block has six identical sides having an outer surface, an inner surface, and four vertices; a magnetic connection element configured to connected at least two inflatable blocks of the number of translucent blocks, wherein the magnetic connection element is located on the inner surface of each of the six identical sides, wherein the magnetic connection element includes four corners, wherein the four corners are equidistant to the four vertices; a proximity switch in communication with a lighting element located on the inner surface of each of the six identical sides, wherein the lighting element is configured to emit colored light when the proximity switch is activated, wherein the proximity switch is activated when the inflatable blocks are connected via their respective magnetic connection elements; and at least one valve for inflating or deflating the inflatable blocks.

### CROSS-REFERENCE TO RELATED APPLICATIONS

The present application is a continuation in part application claiming priority to U.S. patent application Ser. No. 15/047,315, filed on Feb. 18, 2016 entitled “Imagination blocks”, the disclosure of which is hereby incorporated in its entirety at least by reference.

### BACKGROUND OF THE INVENTION

### 1. Field of the Invention

The present invention relates to building blocks. Particularly, the present invention relates to children's building blocks used for the construction of various shapes. More particularly, the present invention relates inflatable magnetic building blocks, which may be magnetically connected together without requiring the user to be concerned with the orientation of magnetic fields.

### 2. Description of Related Art

Building blocks as toys, entertainment and educational items for people young and old are generally known as they permit a user to build and model different structures. Often it has been desired by the user of building blocks to have some form of connection between the blocks so that the developing structure has at least some degree of temporary cohesion.

Permanent magnets are objects made from materials that have been magnetized so as to produce a magnetic field which pulls on other ferromagnetic materials and which attracts or repels other magnets. Moreover, a magnet is generally considered to have two opposite poles, such as North and South. Opposite poles attract while same poles repel.

An inflatable building block with of easy removal, attachment of the building blocks while making structures along with advantage of easy transportation and storage would surely be accepted by the industry.

In prior types of building block inventions for children, the mechanism of attachment and removal is rather complicated, or transportation and storage of building blocks are not easy. A few examples of such are: U.S. Pat. No. 5,746,638 A, U.S. Pat. No. 7,507,136 B2 and U.S. Pat. No. 6,024,626 A.

U.S. Pat. No. 5,746,638 A to Stuff Mfg. Co., Ltd. shows a block toy is composed of a plurality of blocks magnetically connectable to each other. At least one of the blocks comprises a block main body having plural flat surface portions, magnet holding portions formed on inner sides of the respective flat surface portions, and permanent magnets accommodated within the respective magnet holding portions for rotation about imaginary axes extending at right angles relative to the flat surface portions corresponding to the magnet holding portions. The magnet holding portions may be in the form of magnet holders arranged on the inner sides of the respective flat surface portions. The magnet holders may preferably be connected together so that the resulting connected magnet holder has a cross-sectional shape substantially similar to the corresponding cross-sectional shape of the block main body formed by the corresponding plural flat surface portions.

U.S. Pat. No. 7,507,136 B2 to Claire Jean Patton shows a set of magnetic blocks by which connection is made between blocks through a force attracting multiple ferrous protrusions on one face to multiple recessed magnets on another face. The multiple points of magnetic connection provide alignment and rigidity to the assembled structure

U.S. Pat. No. 6,024,626 A to Hillary Singer Mendelsohn shows a magnetic block including an upper face and a lower face and side faces there between and a plurality of magnets located within the blocks.

None of the above inventions and patents, taken either singly or in combination, is seen to disclose an inflatable building block with of easy removal, attachment of the building blocks white making structures along with advantage of easy transportation and storage.

### BRIEF SUMMARY OF THE INVENTION

In one embodiment of the present invention, building blocks for making structures are provided, comprising a number of translucent inflatable blocks, wherein each translucent inflatable block has six identical sides having an outer surface, an inner surface, and four vertices; a magnetic connection element configured to connected at least two inflatable blocks of the number of translucent blocks, wherein the magnetic connection element is located on the inner surface of each of the six identical sides, wherein the magnetic connection element includes four corners, wherein the four corners are equidistant to the four vertices; a proximity switch in communication with a lighting element located on the inner surface of each of the six identical sides, wherein the lighting element is configured to emit colored light when the proximity switch is activated, wherein the proximity switch is activated when the inflatable blocks are connected via their respective magnetic connection elements; and at least one valve for inflating or deflating the inflatable blocks.

In one embodiment, the blocks are made of a light weight material selected from the group of Nylon, Acrylic, Polythene, Polypropylene, Polycarbonate, Bakelite, Epoxy resin, Melamine, PVC or uPVC and combination thereof. In one embodiment, the at least one valve is located on the outer surface of the inflatable block. In another embodiment, the at least one valve located on the outer surface of the inflatable block is depress-able below the outer surface. In yet another embodiment, the lighting element includes at least one LED light. In one embodiment, the outer surface is constructed from a dry erase marker material

The present invention solves the problems of the prior art by providing novel systems for providing magnetic building blocks. The intent of the present invention is to provide a set of building inflatable building blocks for children. The novel block components of this invention are inflatable and therefore easily manipulated by children because the components are made of a soft polyvinyl plastic material that is light in weight.

Another intent of the present invention is to provide a set of magnetic building block, including: a cube shaped block of non-magnetic material having six square faces, an inner surface and an outer surface. Further the inner surface includes the magnetic strips for connecting the building blocks which facilitates the easy attachment and easy removal of the building blocks while making the structures.

Another intent of this invention is to provide for ease in storage and transportation of the disassembled life size toy structure. This object is accomplished because the blocks of the present invention are deflectable, thus, can be stored and transported in a relatively small space.

Each aspect of the invention provides the advantage of easy removal and attachment of the building blocks while making structures.

Each aspect of the invention provides the advantage of easy transportation and storage of the building blocks.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a prospective view illustrating an inflatable building block including a valve according to an embodiment of the present invention; and

FIG. 2 is a prospective view illustrating an inflatable building block including magnetic strips according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide inflatable magnetic building blocks.

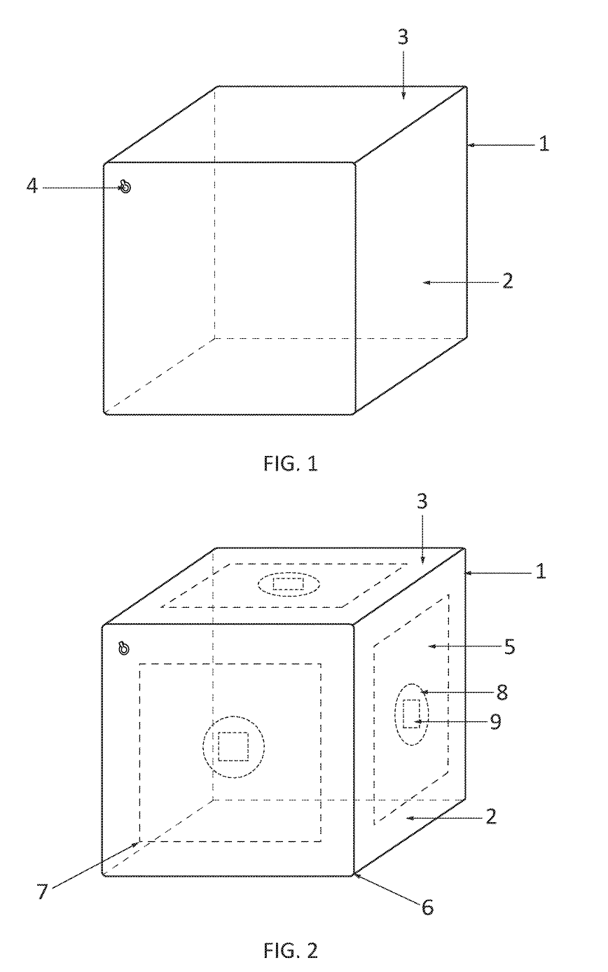

Referring now to the drawings wherein like reference characters designate identical or corresponding parts throughout the figures, and in particular FIGS. 1 and 2 show an embodiment of the inflatable building blocks including magnetic strips and valve.

FIG. 1 shows the prospective view of an inflatable block 01 comprising of an outer surface 02, inner surface 03 and valve 04 for inflating or deflating the inflatable block.

FIG. 2 shows the prospective view of an inflatable block 01 comprising of an outer surface 02, inner surface 03 and means for connecting the inflatable blocks. Each inflatable block has six identical sides having an outer surface 02, an inner surface 03, and four vertices 06. In one the vertices are rounded for safety.

The present invention generally provides a set of building blocks including but not limited to an inflatable block 01, a valve 04 and means for connecting the inflatable blocks.

In general the inflatable block 01 is made of light weight material including the upper surface 02 and the inner surface 03. The outer surface 02 further includes the valve 04 for inflating or deflating the inflatable blocks and means for connecting the inflatable blocks.

In an embodiment of the present invention provide the inflatable building block 01 made of light weight material selected from the group of Nylon, Acrylic, Polythene, Polypropylene, Polycarbonate, Bakelite, Epoxy resin, Melamine, PVC or uPVC and combination thereof including the outer surface 02 and the inner surface 03. The valve 04 for inflating and deflating the inflatable block 01 is depress-able below the outer surface 02 of the inflatable block.

In a preferred embodiment of the present invention, the cubical inflatable block 01 is made of PVC including the outer surface 02 and inner surface 03. In this particular embodiment of the present invention the valve 04 for inflating or deflating the inflatable block 01 is located at the outer surface 02 of the inflatable block 01 and means for connecting the inflatable blocks are magnetic squares 05 located at each inner surface 03 of the inflatable block 01. The magnetic squares include four corners 07 each corner is equidistant to the four vertices of the each inner surface respectively. The magnetic squares are attached to each inner surface using any suitable method known in the art during the initial construction of the inflatable blocks. Further in this particular embodiment of the present invention, the edge of the inflatable cubical block 01 is 18″ long. However, it should be understood that the inflatable block is not limited to this size. In one embodiment, the inflatable cubical block is 14″. In another embodiment, the inflatable cubical block is 16″. In one embodiment, the corners or vertices of the cubical block have a 1″ radius.

In one embodiment of the present invention a lighting element 08 is provided on each inner surface of the inflatable block. In one embodiment, the lighting element is in a centered position. In one embodiment, the lighting element is at least one LED light. The outer and inner surfaces of the inflatable block are translucent allowing the light from the lighting elements to be visible. The color of the light may vary, or may be selectable as well known in the art. Each lighting element is connected to a proximity switch 09, wherein the proximity switch activates the lighting element when connecting two inflatable blocks together via the magnetic squares. In one embodiment, only the lighting element connected to the proximity switch is eliminated. In alternative embodiments, the proximity switches are in communication with each other, such that when one proximity switch is activated, all six of the lighting elements are activated. It is a particular advantage of the present invention, to provide the illuminating lighting elements when two or more blocks are magnetized together facilitating a visual stimulation to children and toddlers correlating the normally unseen properties and phenomenon of magnetism.

In one embodiment of the present invention, the outer surfaces of the inflatable block are constructed with a dry erase marker material capable of accepting dry erase markers. This allows children and toddlers to use, draw, and color design, shapes, and the like using dry erase markers on the outer surfaces.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention. For instance, in one embodiment, the lighting elements may be provided on the outer surfaces of the inflatable block.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

What is claimed is:

1. Building blocks for making structures comprising:
a number of translucent inflatable blocks, wherein each translucent inflatable block has six identical sides having an outer surface, an inner surface, and four vertices;
a magnetic connection element configured to connected at least two inflatable blocks of the number of translucent blocks, wherein the magnetic connection element is located on the inner surface of each of the six identical sides, wherein the magnetic connection element includes four corners, wherein the four corners are equidistant to the four vertices;
a proximity switch in communication with a lighting element located on the inner surface of each of the six identical sides, wherein the lighting element is configured to emit colored light when the proximity switch is activated, wherein the proximity switch is activated when the inflatable blocks are connected via their respective magnetic connection elements; and
at least one valve for inflating or deflating the inflatable blocks.

2. The building blocks of claim 1, wherein the blocks are made of a light weight material selected from the group of Nylon, Acrylic, Polythene, Polypropylene, Polycarbonate, Bakelite, Epoxy resin, Melamine, PVC or uPVC and combination thereof.

3. The building blocks of claim 1, wherein the at least one valve is located on the outer surface of the inflatable block.

4. The building blocks of claim 3, wherein the at least one valve located on the outer surface of the inflatable block is depress-able below the outer surface.

5. The building blocks of claim 1, wherein the lighting element includes at least one LED light.

6. The building blocks of claim 1, wherein the outer surface is constructed from a dry erase marker material.
